(19) United States
(12) Patent Application Publication
(10) Pub. No.: US 2015/0327580 A1
(43) Pub. Date: Nov. 19, 2015

(54) STRAW-BASED FOOD PRODUCT

(71) Applicant: HEIKO KRAUSE, PULSNITZ (DE)

(72) Inventor: HEIKO KRAUSE, PULSNITZ (DE)

(21) Appl. No.: 14/709,659

(22) Filed: May 12, 2015

(30) Foreign Application Priority Data
May 16, 2014 (DE) 10 2014 007 122.7

(51) Int. Cl. A23L 1/10; A23L 1/168

(52) U.S. Cl. CPC A23L 1/1008; A23L 1/1685; A23V 2002/00

(57) ABSTRACT

A dietary food product achieves an improved feeling of well-being. The dietary food product is made of untreated oat straw, that is pureed to form a gruel, and the gruel is then cooked to render it durable. A large vitamin cocktail is added once per day. The food product may be cooked using diverse recipes.

### CROSS-REFERENCE TO RELATED APPLICATION

This application claims the priority, under 35 U.S.C. §119, of German patent application DE 10 2014 007 122.7, filed May 16, 2014; the prior application is herewith incorporated by reference in its entirety.

### BACKGROUND OF THE INVENTION

### Field of the Invention

The invention relates to dietary food for the achievement of an improved feeling of well-being.

The target group is persons who suffer from obesity. This dietary food product is suitable for all people who want to lose weight.

All people who do not have ideal body measurements are deemed to be obese in the meaning of this invention.

This especially occurs after holiday celebrations, such as Christmas, during which too much food is eaten.

The use of the diet that is the subject of the invention can take place after a pregnancy for example, it also helps people who are obese or who have a high-energy diet.

Obesity is always unhealthy. For example, hypertension and diabetes mellitus result from obesity.

The recommended food also serves to prevent human functions such as the secretion of bile, digestion, an increased number of bifidobacteria in the intestines, intestinal gas and arteriosclerosis. A preventative function against cancer can also be assumed.

For example, Chinese patent specification CN 1308899 recommends an edible cellulose that can be directly consumed together with water or beverages or be used as an additive to refined flour, eggs, cake or milk.

U.S. Pat. No. 4,997,665 and its counterpart European patent specification EP 421758 describe dietary fiber and procedures for their production. Hereby, roughage is recommended that has enhanced functional properties and a new antioxidant.

### SUMMARY OF THE INVENTION

It is an object of the invention to provide a novel food which overcomes various disadvantages of the heretofore-known foods this general type.

With the foregoing and other objects in view there is provided, in accordance with the invention, a food product, comprising;

untreated oat straw formed into a gruel by being pureed and subsequently rendered durable by being cooked;

a large vitamin cocktail added to the gruel of pureed oat straw on a daily basis, wherein the food product may be cooked and presented using various recipes.

A diet is kept to on the basis of roughage in order to achieve a weight loss on the basis of the food that is the subject of the invention.

Examples of roughage are edible cellulose and untreated oat straw. The oat straw must be pureed to a gruel using water. This gruel then needs to be cooked so that it is durable.

A large cocktail of vitamins is also added. A single daily addition of vitamins is deemed to suffice. The term large cocktail, in the context, refers to the requirement of the respective consuming person. A large cocktail of vitamins would cover the entire recommended daily vitamin intake of that person.

This forms the basis for all of the recipes and it is a well-balanced meal.

One eats from it each time one feels hungry. If in the form of a soup, the gruel is served warm.

This well-balanced nutrition can be created using different recipes. Examples of recipes are: sweet, sweet-and-sour or sweet with sugar or a synthetically manufactured sweetener, spicy hot.

It is also possible to add flavors such as vanilla, rum, etc., it also being possible to season the food with fresh garlic, fried onions and salt, possibly with pepper, etc.

Seasoning with garlic should preferably be carried out regularly, approx. once per month and the garlic should be eaten 3-4 days in succession, preference being given to 2-3 cloves per meal. This improves the circulation, which is very important.

Calorific energy that is required can be added in the form of various flavors. This is achieved by adding 8% butter, melted bacon or goose fat. 20% pieces of meat or fish can also be added.

A 4-week course of treatment is recommended. One can decide for oneself, how high the weight loss is to be and then organize the diet accordingly.

A duration of 3 months should not be exceeded however. Thereafter, one should keep a balanced diet before repeating this diet.

It is important that the fluid intake is high during this diet.

No milk or dairy products should be taken. Coffee should not be taken, nor should any salads be eaten.

In order to achieve an improved feeling of well-being, the food that is the subject of the invention can be eaten sporadically as a meal, without it being necessary to carry out an entire course of treatment.

The target group is especially females aged 21-60 and males aged 21-39.

In order to improve the achievable results, it is recommended that males who terminate this diet at the age of 39, should continue to build muscles for an additional year, i.e., until attaining the age of 41.

A 14-day course of treatment is recommended for everyone each March in order to prevent cancer. An especially beneficial effect can be achieved by adding garlic to the food for 3-4 days.

Preferably, no work should be carried out during the diet.

The benefits of the recommended food is that roughage is not absorbed by the body. The intestines therefore remain mobile and do not collapse.

The feeling of hunger is reduced. The food can be eaten until one is full. One eats it each time one is hungry. The novel food provides for a balanced diet.

1. A food product, comprising;
untreated oat straw formed into a gruel by being pureed and subsequently rendered durable by being cooked;
a large vitamin cocktail added to the gruel of pureed oat straw on a daily basis, wherein the food product may be cooked and presented using various recipes.

2. The food product according to claim 1, which comprises an added component for energetic enrichment selected from the group consisting of butter, melted bacon, and goose fat.

3. The food product according to claim 1, which comprises an added component for refinement by added flavors selected from the group consisting of vanilla and rum.

4. The food product according to claim 1, which comprises an added component of seasoning selected from the group consisting of fresh garlic, fried onions, salt, and pepper.

5. The food product according to claim 4, which is regularly refined with garlic, to be eaten at least once per month, the food that is refined with fresh garlic being eaten for a duration of 3-4 days in succession.

6. The food product according to claim 5, wherein the food to be eaten three to four days in succession is refined with two to three cloves of garlic per meal.

7. The food product according to claim 1, which comprises an added component of energetic enrichment of approx. 20% pieces of meat or fish.

8. A dietary method, comprising: providing a food product according to claim 1 and exclusively consuming the food product during a four-week diet, subsequently breaking the diet and maintaining a normal, balanced diet, and subsequently repeating the four-week diet with the food product according to claim 1.
